(19) United States
(12) Patent Application Publication
(10) Pub. No.: US 2014/0120506 A1
(43) Pub. Date: May 1, 2014

(54) SCENT MEMORY STRIP

(71) Applicant: Taylor Beukes, Long Beach, CA (US)

(72) Inventor: Taylor Beukes, Long Beach, CA (US)

(21) Appl. No.: 13/663,697

(22) Filed: Oct. 30, 2012

(51) Int. Cl. G09B 19/00

(52) U.S. Cl. 434/236

(57) ABSTRACT

A scent memory strip, which may be called a “Smemory Strip”, includes a malleable and rigid strip of material; a first scent concentrated portion at a first end of the strip; a second scent concentrated portion at a second end of the strip; wherein the strip is adapted to conform to and grip a user's columella so that the strip is retained to the columella; and the strip is adapted to provide a particular scent to the user so that the scent is first associated with a memory when the strip is first used and the scent will be second associated with the same memory at a later time.

### BACKGROUND OF THE INVENTION

The present invention generally relates to scented products and more specifically to a scent memory strip.

Memory may be defined as “the mental capacity or faculty of retaining and reviving facts, events, impressions, etc., or of recalling or recognizing previous experience”. The occurrence of sense may be defined as “any of the faculties, as sight, hearing, smell, taste, or touch by which humans and animals perceive stimuli originating from outside or inside the body”. The sense of smell, specifically, can be both practical and valuable regarding memory.

There is a strong correlation between the memory and the sense of smell. One may have, in the past, smelled a perfume or cologne that an acquaintance once wore and was instantly reminded of that person or an event. One may have smelled a familiar scent that reminded one of details that they did not know that they remembered. The sense of smell in particular is extremely evocative and instrumental in the storage and retrieval of memories; this is believed to be due to the fact that the olfactory bulb is very close in proximity to the parts of the brain associated most strongly with memory. This explains how people create such strong links between particular smells and past memories.

There appears to be a significant correlation between memory and the sense of smell. However, current methods utilize memory and smell separately. In order to unlock the potential and power of smell and memory, a memory, no matter how minute or profound, must be produced during exposure of a particular scent or be somehow coupled with the memory in order for the bond to be created. Once this bond is created, that particular scent and that specific memory will create both a conscious and subconscious link to one another.

Existing nasal strips for aromatherapy may provide scents to users, but they are not designed for studying or test-taking purposes that utilize memory. They may induce some kind of behavior in the user, such as appetite control, but they do not create an association with memory during study and then help recall that same memory later when the same scent is applied.

It would be desirable to bridge the occurrence of memory and the sense of smell together.

### SUMMARY OF THE INVENTION

In one aspect of the present invention, a device includes a malleable and rigid strip of material; a first scent concentrated portion at a first end of the strip; a second scent concentrated portion at a second end of the strip; wherein the strip is adapted to conform to and grip a user's columella so that the strip is retained to the columella; and the strip is adapted to provide a particular scent to the user so that the scent is first associated with a memory when the strip is first used and the scent will be second associated with the same memory at a later time.

In another aspect of the present invention, a method of recalling a memory includes providing a first malleable and rigid strip having first and second ends, each end having a scent concentrated portion; pressing the strip against a columella of a user so that the strip conforms to the columella and is thereby retained so that the scent concentrated portions are proximate to nostrils of the user; creating a memory with the strip in place so that the memory is associated with the scent; and utilizing a second strip having the same scent as the first strip so as to recall the memory.

### BRIEF DESCRIPTION OF THE DRAWINGS

FIG. 1 depicts a perspective view of embodiment of the present invention;

FIG. 2 depicts a top view of the embodiment of FIG. 1;

FIG. 3 depicts a side view of the embodiment of FIG. 1; and

FIGS. 4A, 4B, and 4C depict differently sized embodiments of the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

Embodiments of the present invention may generally include a small, narrow, scented, rigid and yet malleable strip of material that fits under the columella (the visible column of the human nose that lies between both nostrils) comfortably, while breaching or entering the interior of both nostrils only slightly so that it does not interfere with breathing. Embodiments may be referred to as a “Smemory Strip”.

Embodiments may have a particular scent and may be worn during review or study of a particular subject. After exposure to the particular scent chosen by the wearer during study or review, the bond between the memories of studied information may be limited to that specific scent. A variety of scented embodiments may be available to the user, thus creating the potential for a wide assortment of learned and retrievable memories with a variety of scents at the user's disposal.

An embodiment may act as a self-affixed device by using its designed malleability to conform to the specific shape of each person's columella while simultaneously using its rigidity to stay in place after application utilizing friction only. Once applied, an embodiment may provide a steady and uninterrupted scent to the wearer until removal. Embodiments may avoid the use of glues or adhesives to improve its fit or to affix itself to the wearer. Scent concentrated portions at opposite ends of an embodiment may slightly breach the interior of both nostrils and clamp to the sides of the columella. The strip itself may be stiff enough to hold its shape without manipulation, yet be pliable enough to be manipulated.

After initial application of an embodiment, the strip may be manipulated and then hold its manipulated shape and stay affixed to the wearer's nose or columella without additional effort of the wearer. The wearer may simply hold both opposite ends of the strip (preferably with the thumb and index finger of the same hand), place the center of the strip under the center of the columella (the visible part of the human nose that lies between both nostrils), and then gently press both sides of the strip together or toward one another until the strip is securely in place. The application process can be effortless, and most importantly, completely painless. If the intended wearer applies the strip incorrectly or uncomfortably, the strip may be easily removed, bent back to its regular position and then reapplied correctly.

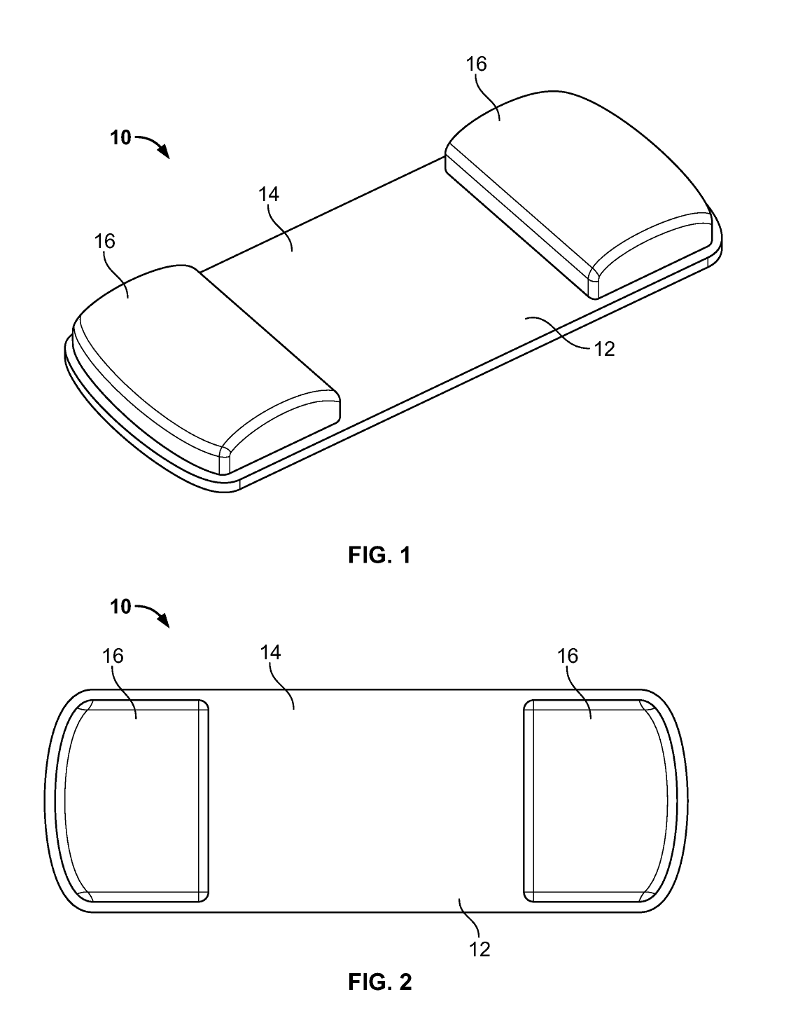

As depicted in FIGS. 1 and 2, an embodiment of a scent memory strip 10 may include a malleable and rigid strip 12. Strip 12 can be folded into a shape and will generally retain that shape, similar to the way a twist tie or pipe cleaner retains a shape. Strip 12 may include or consist of a scented material 14. Both ends of strip 12 may have scent concentrated portions 16. The scented portions may be porous so as to absorb scented oils.

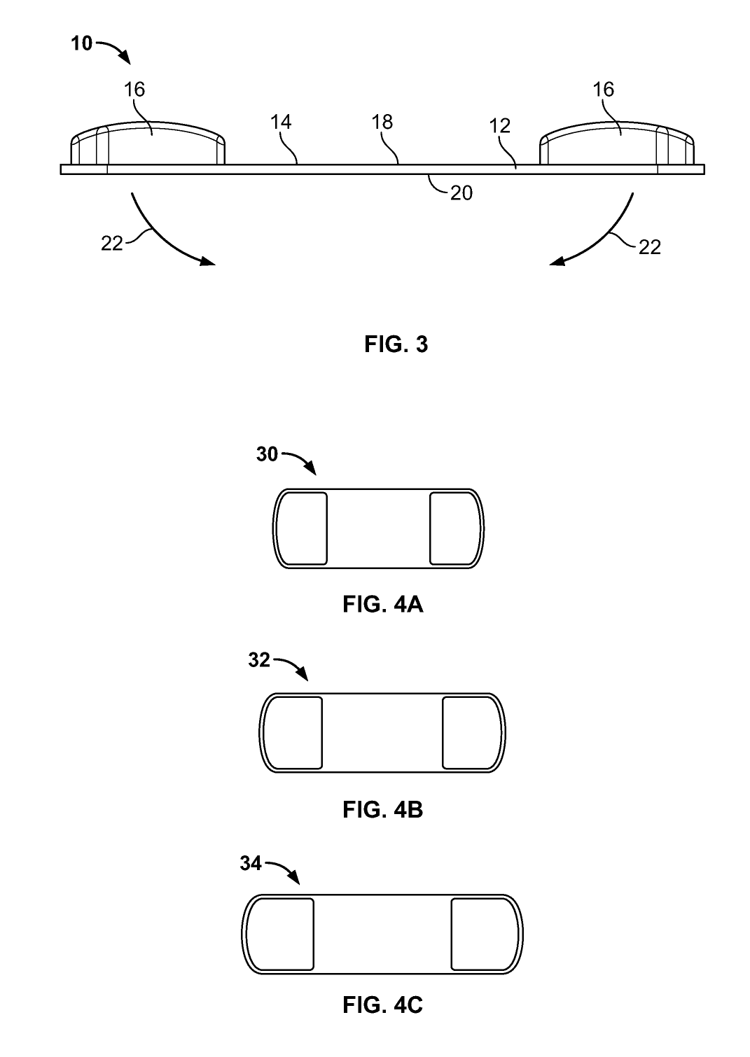

As depicted in FIG. 3, an embodiment of a scent memory strip 10 may have an upper surface 18 and a lower surface 20, and may fold downward in an intended fold direction 22. The lower surface 20 may then conform to the user's nose's columella, so that upon application the scent concentrated porous portions 16 on the upper surface 18 are proximate to or inside the user's nostrils. The scent concentrated portions may be placed specifically to be exposed to airflow that is funneled inside the nostrils during regular inhalation, optimizing their use and effectiveness on smell receptors in the nose.

As depicted in FIGS. 4A, 4B, and 4C, embodiments of a scent strip may be provided in different sizes. Different lengths may accommodate different noses, and may be from ¾″ long to 1.5″ long. A standard width of from ¼″ to 1″, such as 9/32″, may be appropriate for most people. As an example, a small strip 30 may be approximately ¾″ long, a medium strip 32 may be approximately ⅞″ long, and a large strip 34 may be approximately 1″ long. The width of the strips may be, for example, approximately 9/32″. The height of the strips excluding the scent-concentrated portions may be very thin, for example the thickness of a sheet of paper or a band aid. The scent concentrated porous portions may extend out from the upper surface of the strip a short distance.

Because the sense of smell and the occurrence of memory share a strong conscious and subconscious bond, embodiments of the present invention may consciously and strategically create a bond between a particular scent and the memory of studied information or information to the wearer, so retrieval of said information is much more possible and at will of the user. With the application of an embodiment of the present invention, the wearer may be able to tap into the subconscious memories of prior study sessions, where memories are seemingly lost to the wearer's conscious mind but not to their subconscious mind, and better remember those memories during retrieval so that the user may perform better on examinations or testing.

Embodiments may be used for study and test taking purposes, and may give a long and continuous scent to the user. Embodiments may only have an effect on the user while the embodiment is in place, so that the effects will discontinue after removal of the strip. Embodiments may refrain from changing shape when removed from packaging, but will change shape when manipulated by the user. Embodiments may contain scent concentrated portions, adapted for the user's nostrils, and non-scented portions on the strip between the scented portions. Embodiments may include a measurement and mixture of specific oils to achieve the desired memory-retention affect, which may include direct manipulation of the olfactory system in the human brain and its relation to stress and hunger. Embodiments may deal with specific brain pathways having to do with the comprehension and regurgitation of specific and desired information, and may create a link between a specific scent and information chosen by the user in order for the user to better recall said information when desired.

I claim:

1. A device comprising:
a malleable and rigid strip of material;
a first scent concentrated portion at a first end of the strip;
a second scent concentrated portion at a second end of the strip;
wherein the strip is adapted to conform to and grip a user's columella so that the strip is retained to the columella; and
the strip is adapted to provide a particular scent to the user so that the scent is first associated with a memory when the strip is first used and the scent will be second associated with the same memory at a later time.

2. The device of claim 1, wherein the device retains a shape so as to attach to the user utilizing friction.

3. The device of claim 1, wherein the strip includes a scented material between the scent concentrated portions.

4. The device of claim 1, wherein the strip has a length of ¾ inch to 1.5 inch and the strip has a width of ¼ inch to 1 inch.

5. The device of claim 1, wherein the device is adapted to attach to a user's nose so that the scent concentrated portions align with nostrils of the user.

6. The device of claim 1, wherein the device is adapted to conform to a user's columella so that the scent concentrated portions enter into the user's nostrils but do not substantially interfere with breathing.

7. The device of claim 1, wherein the strip can be folded into a shape and will generally retain that shape.

8. The device of claim 1, wherein the strip is malleable enough to conform to the specific shape of a person's columella and is rigid enough to stay in place after application.

9. The device of claim 1, wherein the scented portion is porous so as to contain scented oils within pores.

10. The device of claim 1, wherein the strip provides a particular scent which is first associated with the memory when the user studies and which is second associated with the same memory when the user takes a test.

11. The device of claim 1, wherein scent is provided to the user only when the strip is in place, so that effects will discontinue after removal of the strip.

12. The device of claim 1, wherein strip refrains from changing shape when removed from packaging, but will change shape when manipulated by the user.

13. The device of claim 1, wherein a portion of the strip between the scented portions is non-scented.

14. The device of claim 1, further comprising a plurality of strips having different scents, thereby allowing the user to associate one strip with a first memory and a second strip with a second memory.

15. A method of recalling a memory, comprising:
providing a first malleable and rigid strip having first and second ends, each end having a scent concentrated portion;
pressing the strip against a columella of a user so that the strip conforms to the columella and is thereby retained so that the scent concentrated portions are proximate to nostrils of the user;
creating a memory with the strip in place so that the memory is associated with the scent; and
utilizing a second strip having the same scent as the first strip so as to recall the memory.

16. The method of claim 15, wherein the strip provides a particular scent which is first associated with the memory when the user studies and which is second associated with the same memory when the user takes a test.

17. The method of claim 15, wherein the scent is provided to the user only when the strip is in place, so that effects will discontinue after removal of the strip.
